(19) United States
(12) Patent Application Publication
(10) Pub. No.: US 2006/0143061 A1
(43) Pub. Date: Jun. 29, 2006

(54) MultiPass scheduling system

(75) Inventors: Roderick Sharper, Atlanta, GA (US); Ronald Kegge, Columbus, OH (US)

Correspondence Address: Bingham McCutchen LLP, Suite 1800, Three Embarcadero Center, San Francisco, CA, 94111-4067, US

(73) Assignee: Microsoft Corporation, Redmond, WA (US)

(21) Appl. No.: 11/027,821

(22) Filed: Dec. 29, 2004

(51) Int. Cl. G06F 9/46

(52) U.S. Cl. 705/8

(57) ABSTRACT

A method and apparatus for generating schedules are disclosed. Method includes executing a current algorithm in a sequence of algorithms performing specified scheduling functions and determining a level of progress made by the current algorithm. Method further includes executing the current algorithm while the level of progress meets predetermined criteria and invoking a next algorithm in the sequence if the level of progress does note meet the predetermined criteria.

### FIELD

Embodiments of the invention relate to computerized algorithms for solving combinatorial problems, and more particularly to computerized scheduling solutions.

### BACKGROUND OF THE INVENTION

Every semester schools are faced with enrolling students into student-requested classes. This is not a simple task, as it involves analyzing combinations of schedules to ensure that every student enrolls in every course he or she desires and there are enough seats available in each class to accommodate all student requests. In addition, the task involves generating schedules in such a way that students have contiguous schedules (schedules without gaps) and such that each class instance or section has a student population that is equally representative of gender, ethnicity, or other biographical factors. There are several automated solutions on the market that promise to ease the task of enrolling students into classes. None of those solutions, however, offers a flexible solution that can be used to optimize a variety of school schedule types. Moreover, these solutions utilize single algorithms that fail to provide school administrators with the flexibility to develop scheduling rules and guidelines to be used by automated scheduling systems.

What is needed, therefore, is a solution that overcomes these and other shortcomings of the prior art.

### SUMMARY OF THE INVENTION

To overcome deficiencies of the prior art, the embodiments of the invention are directed to a method and system for generating schedules by a number of algorithms executing in accordance with a set of rules and self-adjusting parameters.

A plurality of algorithms are executed in sequence to perform specified scheduling functions. Each of the algorithms is invoked multiple times while progress is being made by that algorithm.

### BRIEF DESCRIPTION OF THE DRAWINGS

The invention is illustrated by way of example in, but are not limited to, the figures in the accompanying drawings. In the drawings, like references indicate similar elements.

FIG. 1 illustrates the basic logical system components according to some embodiments of the invention.

FIG. 2 is a flow diagram of a multi-pass scheduling process, according to some embodiments of the invention.

FIG. 3A is a flow diagram of a prioritization process, according to some embodiments of the invention.

FIG. 3B is an image displayed by a graphical user interface illustrating schedule statistics, according to some embodiments of the invention.

FIG. 4A is a flow diagram of a first pass scheduling process, according to some embodiments of the invention.

FIG. 4B is an image displayed by a graphical user interface illustrating scheduling statistics, according to some embodiments of the invention;

FIG. 5 is a flow diagram of a second pass scheduling process, according to some embodiments of the invention.

FIG. 6 is a flow diagram of a swapper scheduling process, according to some embodiments of the invention.

FIG. 7 is a flow diagram of a tree search scheduling process, according to some embodiments of the invention.

FIG. 8 is a flow diagram of a re-balancer scheduling process, according to some embodiments of the invention.

FIG. 9A is a flow diagram of a de-gapper scheduling process, according to some embodiments of the invention.

FIG. 9B is an image displayed by a graphical interface illustrating scheduling information, according to some embodiments of the invention.

FIG. 10 is an image displayed by a graphical interface illustrating scheduling information, according to some embodiments of the invention.

FIG. 11A is an image displayed by a graphical interface illustrating scheduling information, according to some embodiments of the invention.

FIG. 11B is an image displayed by a graphical interface illustrating scheduling information, according to some embodiments of the invention.

FIG. 12 illustrates a conventional processing system, according to some embodiment of the invention.

### DETAILED DESCRIPTION

Methods and apparatuses for scheduling are described. Note that in this description, references to “some embodiments” or “an embodiment” mean that the features being referred to are included in at least one embodiment of the invention. Further, separate references to “some embodiments” in this description do not necessarily refer to the same embodiments; however, neither are such embodiments mutually exclusive, unless so stated and except as will be readily apparent to those skilled in the art. Thus, the invention can include any variety of combinations and/or integrations of the embodiments described herein.

Methods and apparatuses for generating schedules are described. Prioritization of objects and requests to be scheduled is utilized in order to generate efficient schedules utilizing a set of rules, predefined and dynamic, and self-adjusting parameters.

System Overview

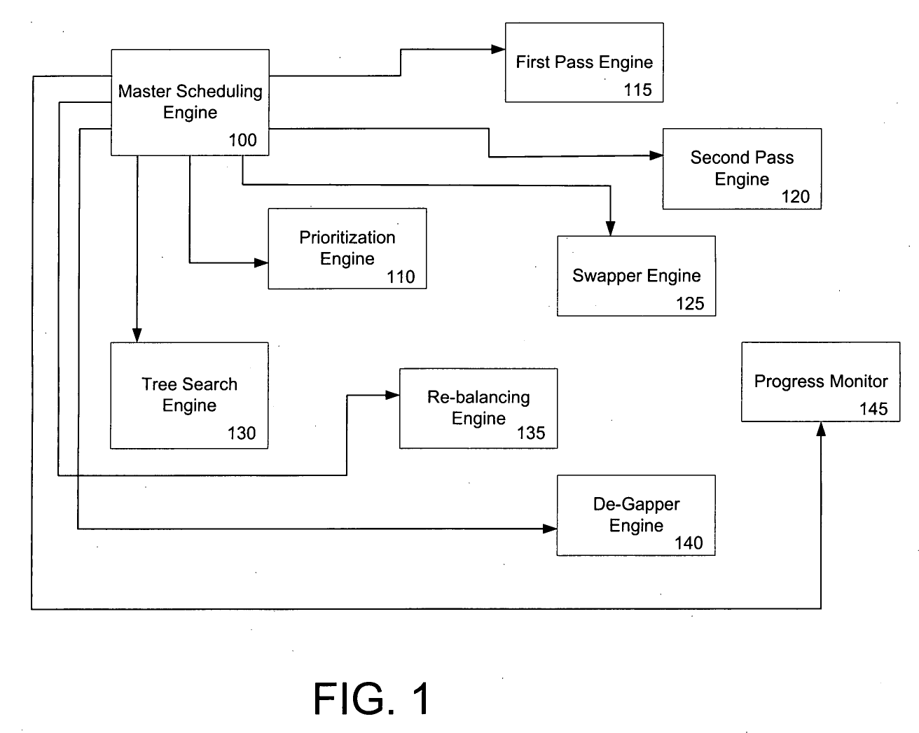

FIG. 1 illustrates components of a scheduling system, according to some embodiments of the invention. A master scheduling engine 100 monitors the scheduling process and invokes algorithms based on pre-defined rules and/or dynamic rules. A prioritization engine 110 prioritizes objects (e.g., students) and requests (e.g., requests for courses). A first pass engine 115 generates a first pass scheduling, whereas a second pass engine 120 generates a second pass scheduling as described in greater detail below. A swapper engine 125 improves the scheduling results by determining and selecting better scheduling scenarios for a number of objects. A tree search engine 130 performs a limited tree search algorithm to improve scheduling results. A re-balancer engine 135 and a de-gapper engine 140 further improve scheduling results as described in detail below. A progress monitor 145 monitors the progress of some of the engines as described in detail below.

Methodology

According to some embodiments of the invention, a user of the scheduling system generates a master schedule of courses available for students to register in. Once the master schedule is generated, the user uploads the data to be used by the scheduling system.

Prioritization

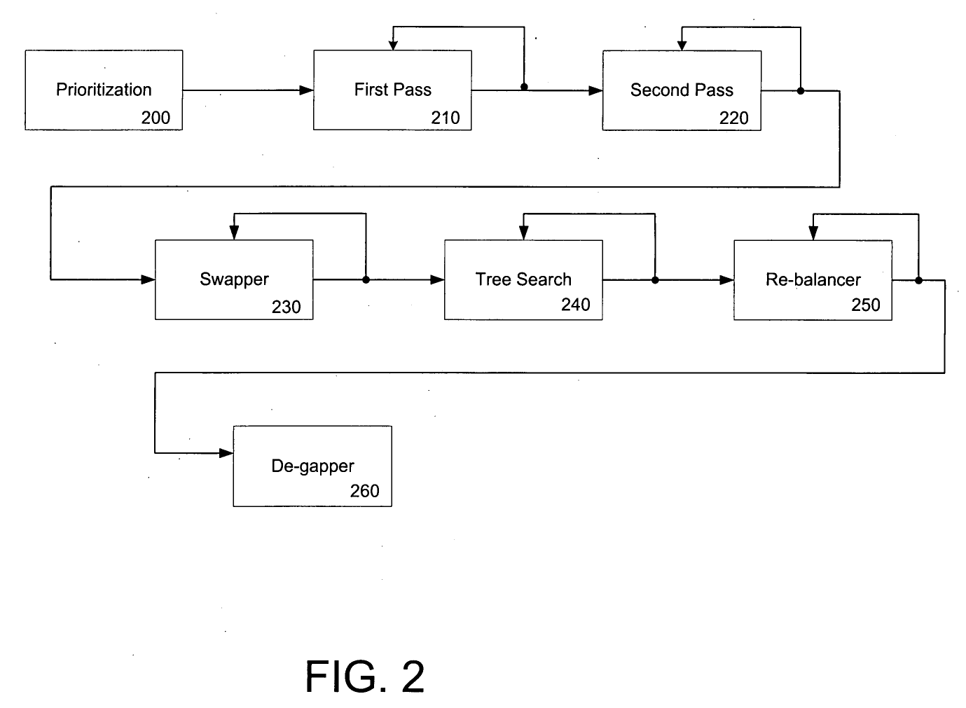

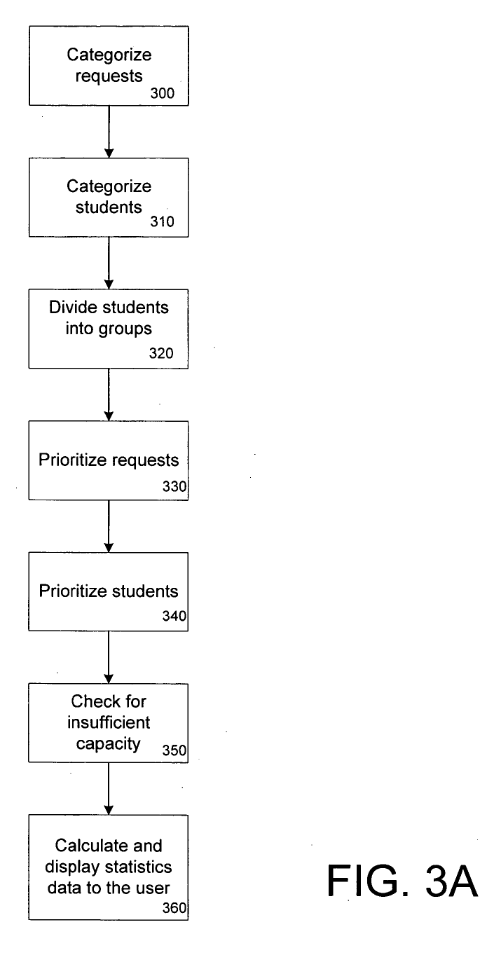

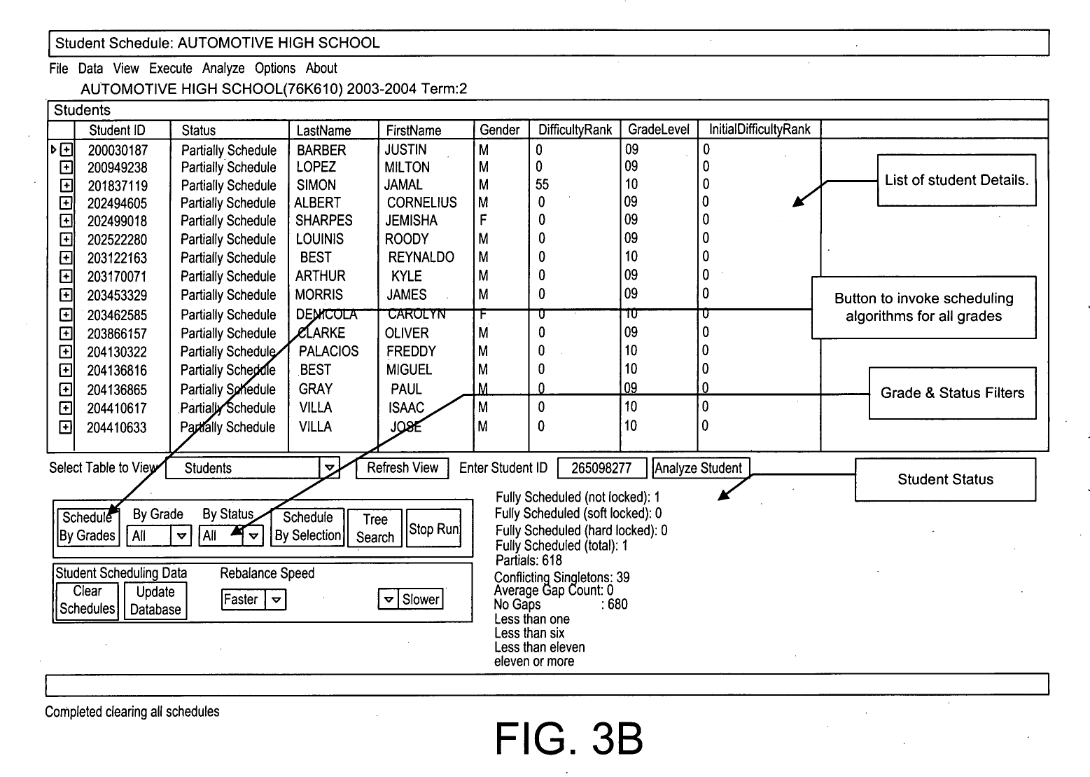

Some embodiments of the invention are described with reference to FIG. 2. At 200 scheduling engine 100 invokes the prioritization engine 110. At 300 of FIG. 3A the prioritization engine 110 categorizes course requests for each student. A request is categorized based on the course that it is requesting and the characteristics of that course (number of sections offered, meeting times, total number of seats available, user provided adjustments). A request may be a normal singleton if it requests a course that is offered only in a single section. For example, if only one section of Math 101 is offered, then a request for Math 101 course is a singleton request. A request may be a conflicting singleton, if it requests a course which conflicts with another singleton. For example, if a singleton Math 101 course meets on Mondays and Wednesday during Period 5 and a singleton English 101 course also meets on Mondays and Wednesday during Period 5, then requests for Math 101 or English 101 are conflicting singleton requests. A request may be a virtual singleton request if it requests a course with only two possible sections and one of these sections conflicting with another singleton. For example, if Social Science 240 course requested by a student is offered in two sections, but one of those sections conflicts with a singleton Math 101 course requested by the same student, then the request for Social Science 240 course is a virtual singleton. A request may also be a virtual singleton if more than one section option is available after eliminating those that conflict with singletons and virtual singletons, but all of the remaining options meet at the same time. For example, if Social Science 240 is offered in three sections, but one of those sections conflicts with a singleton Math 101 course and the remaining two sections meet at the same time, then the request for Social Science 240 is a virtual singleton. A request may be a conflicting virtual singleton request if it requests a course that conflicts with another virtual singleton or a normal singleton course. Requests may be irresolvable if they request courses with undefined sections or with no non-conflicting sections. The requests may also be categorized as a normal request, which is a request for a course that is neither a singleton nor unresolvable.

At 310 the prioritization engine 110 categorizes all the students based on categories of their requests. A student may be categorized as a fully scheduled student (i.e., a student with all of his/her requests already satisfied), an irresolvable student (i.e., a student requesting courses with unresolvable conflicts), or a partially scheduled student (i.e., a student with a subset of his/her requests already satisfied).

Upon categorization of requests and students, the prioritization engine 110 prioritizes students and requests according to some embodiments of the invention. At 320 of FIG. 3 the prioritization engine 110 separates students into groups. For example, the prioritization engine 110 separates school students by grades, generating a 12^{th} graders group, an 11^{th} graders group, etc. At 330 the prioritization engine 110 prioritizes student requests. In some embodiments, the prioritization engine 110 prioritizes the requests based on degree of scheduling difficulty utilizing pre-defined rules, which may include user-defined rules. The user of the scheduling system may manually specify degree of difficulty for some or all of the courses prior to loading the data into the system. The prioritization engine 110 utilizes these user-defined degrees of difficulty when prioritizing student requests. Courses that were not assigned a degree of difficulty by the user are initially assigned the same degree of difficulty (e.g., the lowest degree of difficulty). The prioritization engine 110 modifies (e.g., increases) the threshold values based on a set of pre-defined rules, which may include user-defined rules. For example, the user pre-defined rules may specify that requests for Honors courses are to be assigned the highest degree of difficulty and requests for Physical Education courses are to be assigned the lowest degree of difficulty. The user pre-defined rules may be based on scheduling experiences from prior semesters/years at the school, for example, if in several previous years the Honors classes were the most popular courses then they are difficult to schedule as more students request these courses and few seats in these classes are available.

The pre-defined rules may also include a rule which specifies that courses with fewer sections are assigned higher degree of difficulty than courses with greater number sections. If English 101 course has three separate sections and Math 101 has only one section, then Math 101 is assigned a higher degree of scheduling difficulty than English 101 course. In this situation, the prioritization engine 110 increases the value of the degree of difficulty for Math 101 course by a greater amount than the value of the degree of difficulty for English 101. The pre-defined rules may also include a rule that directs the prioritization engine 110 to assign a higher degree of difficulty to courses that require students to attend it several times a week. For example, if English 101 course meets 5 times a week and Math 101 course meets only once a week, then English 101 course will be assigned a higher degree of difficulty than Math 101 course according to some embodiments. According to some embodiments, each rule for assigning degrees of difficulty is associated with an increment value to be added to the degree of difficulty already assigned to a course. It will be appreciated by one skilled in the art that embodiments of the invention are not limited to the rules described above and a variety of other pre-defined rules and user-defined rules may be used in determining most efficient schedules.

At 340 of FIG. 3A, upon prioritization of the courses, the prioritization engine 110 prioritizes the students in each group. For example, the prioritization engine 110 first prioritizes the 12^{th} graders group, then the 11^{th} graders group, etc. Students are prioritized based on degrees of difficulty of their course requests. In some embodiments student degrees of difficulty are set to the sum of difficulty of all student's course requests. For example, if student David requested English 101 with a degree of difficulty of 10, Math 101 with a degree of difficulty of 20 and Social Sciences 240 with a degree of difficulty of 3, David's degree of scheduling difficulty is 33.

According to some embodiments, the prioritization engine 110 may prioritize the students based on student IDs, student grade levels, gender, etc. For example, students who are in 12^{th} grade may be more difficult to schedule because all of their requests must be satisfied in order for them to graduate. It will be appreciated by one skilled in the art that a variety of predefined rules may be utilized by the prioritization engine 110 to prioritize students and the embodiments of the invention are not limited to the rules described above.

Once the students and requests are prioritized, at 350 the prioritization engine 110 checks courses for insufficient capacity. The prioritization engine 110 determines whether for every course the total number of requests do not exceed the total number of seats available in all sections of that course. If the total number of requests exceeds the total number of seats, the prioritization engine 110 flags the course as a problematic one. The scheduling system then informs the user of the system about such problematic courses according to some embodiments. This information may allow the user to modify the master schedule, e.g., by adding an extra section for the course, to accommodate all student requests.

At 360 the prioritization engine 110 calculates and displays statistics to the user. FIG. 3B illustrates a sample graphic user interface that may be presented to the user. The interface may indicate the total number of fully scheduled students, the total number of partially scheduled students and the total number of irresolvable students. The prioritization engine 110 may also specify the number of students that are hard-locked, soft-locked and not locked. The user may manually schedule some of the students prior to invoking the scheduling system and specify those schedules to be hard-locked, which prevents the scheduling system from un-scheduling these students in order to accommodate other student requests. The user may manually schedule some of the students and specify those students to be soft-locked, which allows the scheduling system to un-schedule this students only if these students can remain fully scheduled and not become partially scheduled students due to the un-scheduling.

The prioritization engine 110 may also calculate and display statistics regarding gaps in students schedules. If some of the students are already scheduled, then the prioritization engine 110 may specify the number of students with zero gaps in their schedule, with less than one gap in their schedule, with 6 or fewer gaps in their schedules, with less than 11 gaps in their schedules and with greater than 11 gaps in their schedules.

It will be appreciated by one skilled in the art that other type of statistics information may be displayed to the user, e.g., gender of students, age, etc., and the embodiments of the invention are not limited to the statistics data described above. The user of the scheduling system by analyzing the displayed statistics data may determine whether the master schedule needs to be changed to accommodate all student requests.

First Pass

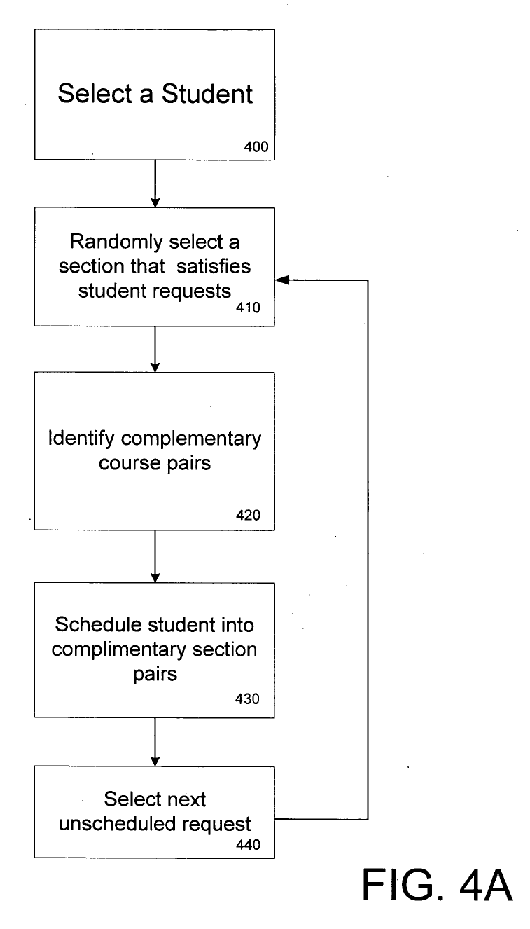

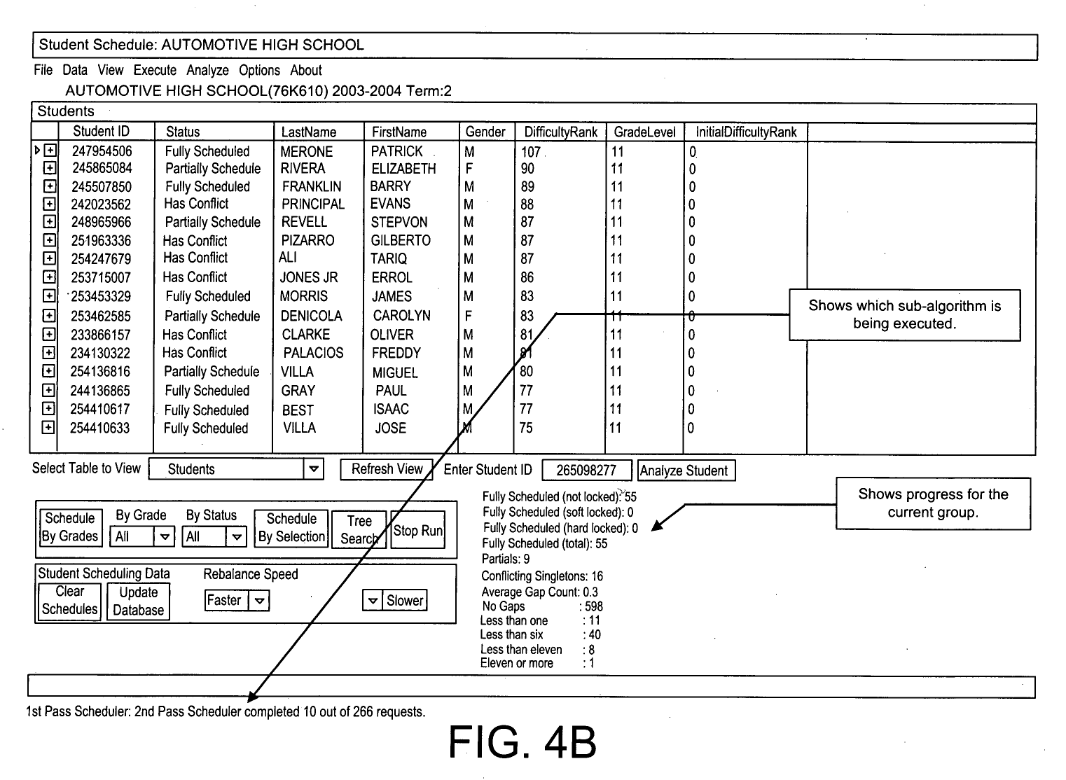

Once the requests and students are prioritized, scheduling engine 100 invokes the first pass engine 115 at 210 of FIG. 2 to execute a first pass algorithm according to some embodiments of the invention. At 400 of FIG. 4A the first pass engine 115 selects the most difficult to schedule student from a current group being scheduled, e.g., 12^{th} graders group, 11^{th} graders group, etc. Once the student is selected, the first pass engine 115 selects a random section of one of the student's requested courses at 410. In some embodiments the selected section satisfies the basic business rules, for example, the selected section does not conflict with the student's current schedule, has seats available, is a section of an allowed alternate course, meets gender or language restrictions. The first pass engine 115 may randomly select a section of the requested course, or it may select a section with the most available seats. For example, if the selected student requested English 101, Math 101 and Social Sciences 240, the first pass engine 115 either randomly selects a section of either English 101, Math 101 or Social Sciences 240 to satisfy student requests or selects a section of English 101, Math 101 or Social Sciences 240 with the most available seats.

At 420 the first pass engine identifies course pairs that complement each other. Complementary sections are two or more course-sections for different requests that if scheduled together would produce the fewest number of gaps in the student's schedule. Gaps are period of times in a student's schedule during which there are no scheduled classes. For example, in a school with a standard 5 day schedule rotation, if a student has requested Biology Lecture and Biology Lab courses and Biology Lecture meets on Monday, Tuesday, Wednesday and Friday in Period 2 and a section of Biology Lab meets on Thursday in Period 2, then these two sections are complementary as they generate the fewest number of gaps (the student has a class to go to during Period 2 every day of the week). At 430 if the first pass engine 115 identifies complementary pairs for a particular student, then it selects a complementary pair with the highest average number of remaining seats in both sections and schedules the student for this pair. In some embodiments, if the complementary pairs were not found, the first pass engine 115 schedules courses that are partially complementary pairs. Partially complementary pairs are section pairs that have a partial gap. For example, if Biology Lecture meets on Monday, Tuesday and Friday in Period 2 and Art Lab meets on Thursday in Period 2, leaving a gap on Wednesday during Period 2, the Biology Lecture and Art Lab are partially complementary pairs. If partially complementary pairs were found, the first pass engine 115 selects the partially complementary pair with the highest average number of open seats and schedules the student for this pair of sections. In some embodiments the user may configure the scheduling system to not search for complementary and/or partially complementary pairs. Upon scheduling a request for the particular student, the first pass engine 115 at 440 selects the next unscheduled request for the student and selects a section for the request in a manner described above.

According to some embodiments, upon attempting to schedule all the requests for a given student, the first pass engine 115 selects another student from the group to schedule. Upon attempting to schedule all the students in the group, the progress monitor 145 determines whether to invoke the first pass engine 115 one more time. The progress monitor 145 calculates the percentage of students who were fully scheduled in the last pass of the first pass engine 115. If the progress has been made, then the progress monitor 145 invokes the first pass engine 115 again, upon which the first pass engine 115 attempts to schedule partially scheduled or unscheduled students in a manner described above. The progress monitor 145 determines whether a pass was successful by calculating the change in percentages of students that became fully scheduled from the last pass, if the difference is greater than a pre-defined threshold then the progress monitor 145 invokes the first pass engine 115 again, if the difference is less than the pre-defined threshold then the progress monitor 145 does not invoke the first pass engine 115 again.

FIG. 4B illustrates an exemplary graphical user interface presented to the user during the execution of the first pass engine. The interface displays current statistics and scheduling progress to the user of the scheduling system. It will be appreciated that graphical display of statistics and/or scheduling progress can be displayed to the user at the end and during execution of each of the described engines.

Second Pass

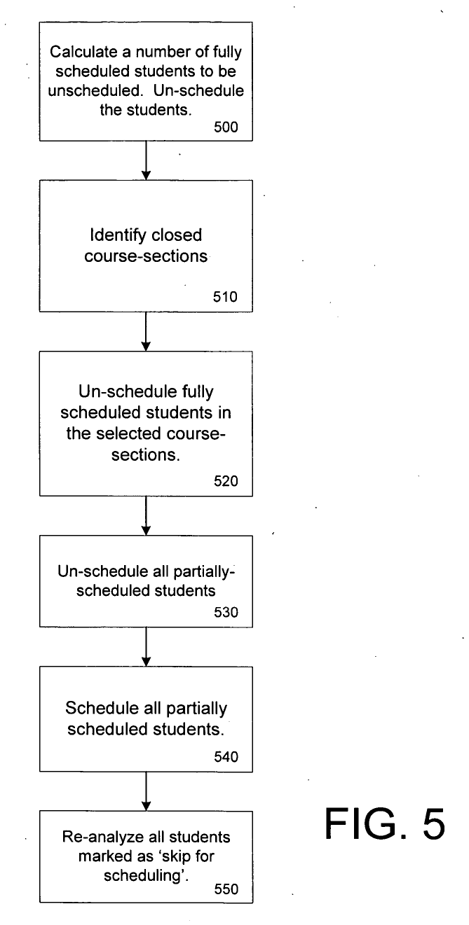

Once the first pass engine 115 attempts to schedule all the students in the group and it is not being invoked again by the progress monitor 135, scheduling engine 100 invokes the second pass engine 120 at 220 of FIG. 2 to execute a second pass algorithm according to some embodiments of the invention. At 500 of FIG. 5, the second pass engine 120 un-schedules a percentage of fully scheduled students. In some embodiments the percentage of students to un-schedule is determined by a number of partially scheduled students and a predetermined rate of un-scheduling. For example, the predetermined rate of un-scheduling, which is user-configured or hard-coded, may be set to 4 percent. The predetermined rate of un-scheduling may be set to any value and the embodiments are not limited to 4 percent. In some embodiments the number of fully-scheduled students to be un-scheduled is determined by the following formula:
0.4 * NumberofPartiallyScheduledStudents * RateofUnscheduling

At 510, the second pass engine 120 identifies closed course sections. Closed course sections are sections in to which a maximum number of students has been already scheduled and there are no more seats available. In some embodiments, the second pass engine 120 randomly selects eight closed course sections. If the total number of closed course sections is less than eight, then the second pass engine 120 selects all the closed course sections. The value of eight closed course sections is the default. Other values can be specified in a system configuration file and the embodiments are not limited to the value of eight closed course sections.

At 520, for each of the closed sections the second pass engine 120 randomly selects a number, that was determined by the above formula, of fully scheduled students that are enrolled in each of the closed sections and un-schedules these students from all the courses that those students are scheduled in. The status of these students is then set to Don't Schedule. At 530 the second pass engine 120 then un-schedules all partially-scheduled students and invokes the first pass engine 115 at 540 to schedule all partially scheduled students and to ignore students with Don't Schedule status. Upon the first pass engine 115 finishing the scheduling of all-partially scheduled students, the second pass engine 120 at 550 re-analyzes students with Don't Schedule status by re-categorizing requests, re-evaluating request difficulty and setting student schedule status to fully-scheduled, partially scheduled or irresolvable. Students with Don't Schedule status may be scheduled during a subsequent iteration of the second pass algorithm as determined by the progress monitor. Alternatively, students with Don't Schedule status may be scheduled by the next algorithm to be invoked.

Once the second pass engine 120 attempts to fully schedule all the students in the group, the progress monitor 145 determines whether to invoke the second pass engine 120 again in a manner described above. The progress monitor 140 continues to invoke the second pass engine 120 until it stops making sufficient progress.

It will be appreciated by one skilled in the art that different criteria may be used by the progress monitor in determining whether sufficient progress has been made by an engine and embodiments of the invention are not limited to the described criteria.

Swapper Engine

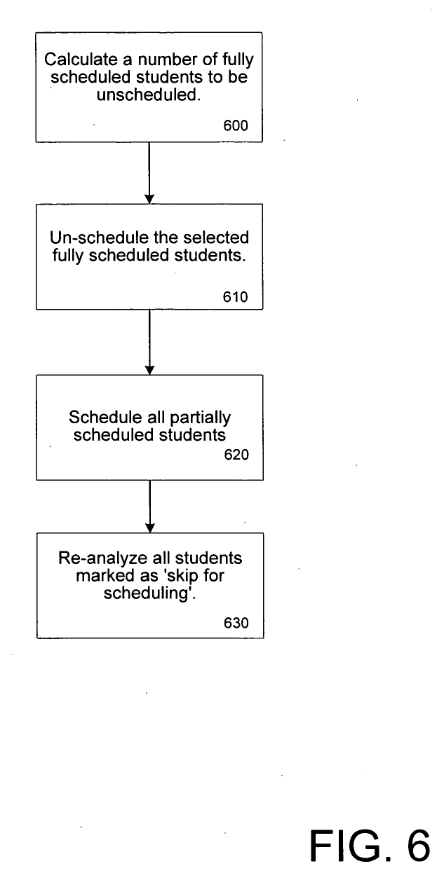

Once the second pass engine 120 attempts to schedule all the students that were not fully scheduled by the first pass engine 115 and the progress monitor 145 does not invoke the second pass engine 120 again, scheduling engine 100 invokes the swapper engine 125 at 220 of FIG. 2 to execute the swapper algorithm according to some embodiments. At 600 of FIG. 6 the swapper engine 125 selects, a number of fully scheduled students based on a number of partially scheduled students and the rate of un-scheduling. In some embodiments, the swapper engine 125 calculates the number of fully scheduled students to be un-scheduled based on the following formula:
NumberofPartiallyScheduledStidents * RateofUnscheduling

At 610, upon randomly selecting the calculated number of fully scheduled students, the swapper engine 125 fully un-schedules the selected students. Thus, if student Marc with a full schedule was selected, none of Marc's requests will be satisfied after the swapper engine 125 un-schedules his schedule. According to some embodiments, the swapper engine 125 sets status of the un-scheduled students to “Don't Schedule.” At 620 the swapper engine 125 identifies partially scheduled students, i.e. students that were not fully scheduled by the first pass engine 115 and the second pass engine 120 and invokes the first pass engine 115 directing it to schedule all partially scheduled students. In some embodiments, the first pass engine 115 ignores the students with “Don't Schedule” status. It will be appreciated by one skilled in the art that an engine may invoke any other algorithm to schedule a subset of the students and embodiments of the invention are not limited to the invocation of the first pass engine or any other engine.

At 630 the swapper engine 125 re-analyzes all students with “Don't Schedule” status by re-categorizing requests, re-evaluating request difficulty, and setting student schedule status to fully-scheduled, partially schedule or irresolvable. Students with Don't Schedule status may be scheduled during a subsequent iteration of the second pass algorithm as determined by the progress monitor. Alternatively, students with Don't Schedule status may be scheduled by the next algorithm to be invoked.

Once the swapper engine 125 attempts to fully schedule all the students in the group, the progress monitor 145 determines whether sufficient progress has been made by the swapper engine 125 to invoke the engine again. The functionality of the progress monitor 145 has been described above.

Tree search

Once the swapper engine 125 has finished attempting to satisfy requests of partially-scheduled students and the progress monitor 145 has determined that the swapper engine 125 does not sufficiently progress, scheduling engine 100 invokes the tree search engine 130 at 240 of FIG. 2 to execute a tree search algorithm according to some embodiments. In some embodiments, the tree search algorithm is time-limited and branch-limited, i.e. the tree search engine 130 when executing the tree search algorithm does not exceed the branch limit number and performs the algorithm in the limited time. The initial branch limit may be set based on the ratio of fully scheduled students over partially scheduled students at the time the tree search engine 130 is invoked. For example, the initial branch limit may be set to the result of the following calculation if the result is less than 100, if the result is not less than 100 then the initial branch limit may be set to 100:
50+10* (fully-scheduled/partially scheduled)

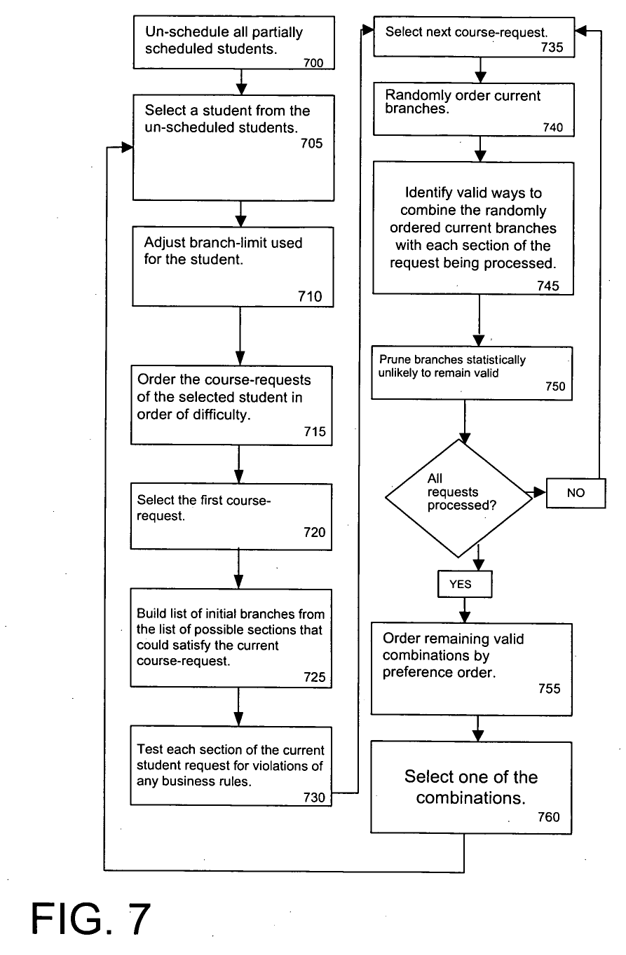

At 700 of FIG. 7, the tree search engine 130 identifies all partially scheduled students within the current group and un-schedules the identified students. At 705 the tree search engine 130 selects a student from the current group to schedule. The tree search engine 130 may select students to schedule based on their assigned difficulty degree is the descending order, i.e. selecting first students with the highest degree of difficulty. At 710 the tree search engine 130 adjusts the initial branch limit for the tree search algorithm for the selected student. The initial branch limit adjustment depends on a variety of factors and calculations. For example, the adjustment depends on the number of possible course section combinations to satisfy requests of a student that the tree search engine 130 is attempting to schedule. Possible course section combinations may be calculated by raising the number of student's requests into a power of an average number of sections per request. If the initial branch limit is less than 3% of possible combinations, then the tree search engine 130 increases the branch limit by 10%. The adjustment is also based on the ratio of the number of fully scheduled students over the total student population. If the ratio is higher than 80% percent then the tree search engine 130 increases the branch limit by 10%. These percentage point values may be specified in a configuration file and the embodiments are not limited to the values specified above.

The adjusted branch limit also depends on the average running time of previous tree search algorithms. If more than 50% of a predefined number of last tree searches have timed out, i.e. have reached the time limit before the schedule has been finalized, then the tree search engine 130 decreases the branch limit by 10%.

In some embodiments the branch limit is pre-assigned a maximum and a minimum threshold. The tree search engine 130 compares the adjusted branch limit to the thresholds to ensure that that adjusted branch limit is not greater than the maximum threshold and not less than the minimum threshold.

Once the branch limit is adjusted, the tree search engine 130 at 715 creates a list of student requests which is ordered by difficulty: the most difficult requests to schedule are placed on the top of the list. Once the list of requests is created, the tree search engine 130 selects the first course request from the list at 720. The tree search engine 130 the creates a list of all valid course request combinations within the branch limit and time limit for the selected student. At 725 if branch-limits are specified, the tree-search engine limits which combinations are enumerated by randomly choosing starting branches, but in such a way that the starting braches are distributed evenly across all the course offerings (sections) and is statistically weighted towards those branches that have successfully scheduled other students. For example, if a student requested to take courses Math 101 and English 101, the course request that is determined to have the highest difficulty rank, let's say Math 101, is selected first by the tree-search algorithm. Each section of Math 101 is considered as a possible starting branch or branch root. If the number of sections is more than the current branch limit, the described branch selection process is invoked so that only a number equal to or less than the branch limit remain. Next, each of the sections of English 101 is combined with the list of current valid combinations. The list is quasi-randomly sorted with sort order weighted toward those combinations which have been successful for other students in the school. Each successful combination is kept as a starting branch for the next course to be added. If branch limits are specified, each section of English 101 is combined with existing starting branches from the list until a number equal to ((1/total number of English 101 sections)*BranchLimit) of successful combinations is reached. Options may be specified, which direct the tree search engine 130 to not process fully scheduled and/or irresolvable students. Other options may be specified which direct the tree search engine 130 to exclude certain sections from consideration when enumerating combinations and/or only consider enumerations which provide a full schedule that satisfies all of the requests for a given student.

At 730 the tree search engine 130 tests each section for the current student request to see if it can be combined with the current randomly sorted starting branch population without violating any of the business rules. If a branch limit is specified, each section may only produce a number of valid combinations equal to (branch-limit*(1/number number-of-sections)). For example, if there are four sections offered for one of the courses that the student requested and the branch limit is 100, the tree search engine 130 tests each section against the current starting branch population until a maximum of 25 valid combinations are found for each section. For each newly added combination the tree search engine 130 updates gap and population statistics. That is, the number of gaps or holes in each section combination is evaluated as well as the lowest number of remaining seats in any of the sections in that combination.

At 735 the tree search engine 130 selects the next course-request from the current student requests. At 740 the tree search engine 130 randomly orders current branches and at 745 the engine identifies up to the branch limit valid combinations of the randomly ordered current branches with each section of the current request being processed. In some embodiments each section of the current request being processed contributes an equal number of new valid starting branches.

At 750 the tree search engine 130 prunes out branch combinations that are likely not to be valid as they violate some of the business rules, for example, sections with conflicting meeting times. The number of branches that are pruned may depend on the overall system constraint and number of possible combinations for the student. For example, the higher the overall system constraint and the number of possible combinations for the student, the higher number of branches are pruned by the tree search engine 130. In some embodiments the level of system constraint is proportional to the ratio of (a number of fully schedule students/entire student population count). The level of system constraint may also be proportional to the ratio of (number of closed course sections/total number of course sections). The level of system constraint may also be inversely proportional to the estimated number of possible course section combinations for the student being scheduled as calculated by the formula presented above.

Once the list of combinations is generated, the tree search engine 130 identifies valid combinations. Schedule combinations that include conflicts are deleted from the list. At 755, after all current student requests have been scheduled, the tree search engine orders all valid combinations by gap count ascending and lowest section capacity descending, i.e. the lowest capacity of any section in the combination. At 760 the tree search engine selects a number of top valid combinations, for example top 20%. The tree search engine 130 then randomly selects a combination from the selected top combinations according to some embodiments. In some embodiments the tree search engine selects the first combination from the selected top combinations. Once the combination is selected the student is scheduled with the selected combination of courses.

The manner in which the tree search algorithm iterates the possible permutations of combinations of course-sections is best illustrated with a simple example. Let's suppose that a student is requesting three different courses. Imagine that the first course is represented by letters of the alphabet, the second course is represented by numbers (positive integers less than 7) and the third course is represented by color names. Thus, we need to build a set of combination permutations of letters, numbers, and colors. Let us also imagine the following rules for the combinations in order for them to be valid combinations:
Rule 1: Capital letters can only be combined with even numbers and colors whose names have an even number of letters.
Rule 2: Lower case letters can only be combined with odd numbers. -p1 Rule 3: Even numbers can only be combined with colors whose names start with A or R.
Color names are limited to “Azure”, “Blue”

Let us also imagine that a branch limit of 4 is specified. Let us also imagine that letters have the highest difficulty rank, numbers have the next highest, and colors have the third highest.

When the tree-search algorithm executes, it would start by selecting a starting population of branches from the list of possible letters. Since only 4 may be used (due to the branch limit), four letters are selected randomly with weighting (increased probability of selection) given to those letters that have previously generated successful schedules. A table of the current branches might look like the following:

| | | |
|---|---|---|
| Letters | Numbers | Colors |

A
c
G
m

Next a number is chosen. First the starting branches (currently only consisting of letters) is sorted randomly and optionally, those letters that have produced the highest number of successful combinations previously are moved up in the list. Let us suppose that this sorting result in the following order: G, c, m, A. Now, the first number for consideration, the number “1”, is compared with each of the starting branches. Notice that each number only produced 2 valid combinations of Letters and Numbers, thus the branch limit is not invoked.

| | Letters | Numbers | Colors |
|---|---|---|---|
| Invalid (rule 1) | G | 1 | |
| 1 | c | 1 | |
| 2 | m | 1 | |
| Invalid (rule 1) | A | 1 | |
| 3 | G | 2 | |
| Invalid (rule 2) | c | 2 | |
| Invalid (rule 2) | m | 2 | |
| 4 | A | 2 | |
| Invalid (rule 1) | G | 3 | |
| 5 | c | 3 | |
| 6 | m | 3 | |
| Invalid (rule 1) | A | 3 | |
| 7 | G | 4 | |
| Invalid (rule 2) | c | 4 | |
| Invalid (rule 2) | m | 4 | |
| 8 | A | 4 | |
| Invalid (rule 1) | G | 5 | |
| 9 | c | 5 | |
| 10 | m | 5 | |
| Invalid (rule 1) | A | 5 | |
| 11 | G | 6 | |
| Invalid (rule 2) | c | 6 | |
| Invalid (rule 2) | m | 6 | |
| 12 | A | 6 | |

Next a color name is chosen. The list of 12 remaining valid Letter-Number combinations is again randomly ordered with possible preferential ordering given to previously successful Letter-Number combinations. The first color-name to be tested is “Azure”. Since there are two possible colors and the branch-limit is 4, each color can only contribute a maximum of 2 valid combinations.

| | Letters | Numbers | Colors |
|---|---|---|---|
| 1 | G | 6 | Azure |
| 2 | m | 1 | Azure |
| STOP Max | G | 2 | Azure |
| reached | | | |
| | A | 2 | Azure |
| | c | 3 | Azure |
| | m | 5 | Azure |
| | G | 4 | Azure |
| | A | 4 | Azure |
| | c | 1 | Azure |
| | m | 3 | Azure |
| | c | 5 | Azure |
| | A | 6 | Azure |

Next, the color “Blue” is tested:

| | Letters | Numbers | Colors |
|---|---|---|---|
| Invalid (Rule 3) | G | 6 | Blue |
| 2 | m | 1 | Blue |
| Invalid (Rule 3) | G | 2 | Blue |
| Invalid (Rule 3) | A | 2 | Blue |
| 5 | c | 3 | Blue |
| STOP Max reached | m | 5 | Blue |
| 7 | G | 4 | Blue |
| 8 | A | 4 | Blue |
| 9 | c | 1 | Blue |
| 10 | m | 3 | Blue |
| 11 | c | 5 | Blue |
| 12 | A | 6 | Blue |

Thus the resulting combinations would be:

| | Letters | Numbers | Colors |
|---|---|---|---|
| 1 | G | 6 | Azure |
| 2 | m | 1 | Azure |
| 3 | m | 1 | Blue |
| 4 | c | 3 | Blue |

Once the tree search engine 130 attempts to fully schedule all the students in the group, the progress monitor 145 determines whether sufficient progress has been made by the engine to invoke the engine again. The functionality of the progress monitor 145 has been described above.

Re-balancer

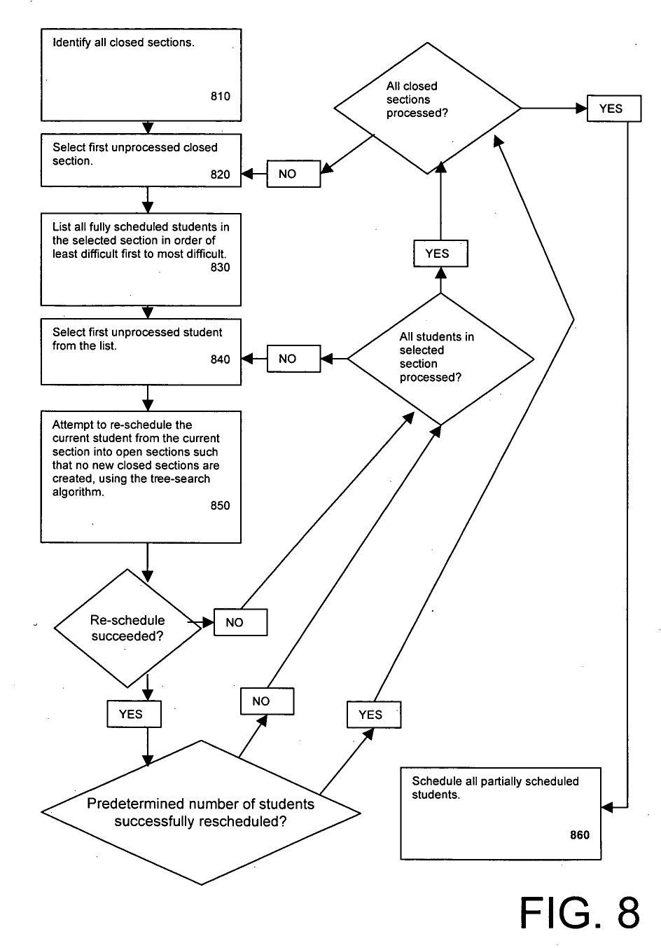

Once the tree search engine 130 has finished attempting to satisfy requests for all the students and the progress monitor 125 stops invoking the tree search engine 135, scheduling engine 100 invokes the re-balancer engine 135 at 250 of FIG. 2 to execute a re-balancer algorithm according to some embodiments of the invention. The re-balancer algorithm attempts to schedule students with partial schedules that are required to be placed in a course wit closed sections in order to satisfy their requests. At 810 of FIG. 8 the re-balancer engine 135 identifies closed sections of courses. For example, if English 101 is offered in 3 different sections and two of them are already closed, because the maximum number of students were already placed in those sections, then the re-balancer engine 135 identifies these two closed sections. The re-balancer engine randomly orders the identified closed sections. At 820 the re-balancer engine 135 selects the first section from the ordered list. At 830 the engine lists all fully scheduled students in the selection section in order of least difficult to most difficult. Once the fully scheduled students in the selected sections are ordered, at 840 the re-balancer engine 135 selects the first student from the list and at 850 the engine attempts to schedule the selected student from the current closed section into an open section for that course such that no new closed sections are created. The number of selected fully scheduled students to re-enroll depends on a number of fully scheduled students versus partially scheduled students and a number of closed course sections versus a number of open course sections. In some embodiments the number of fully schedule students to enroll may be user-specified. According to some embodiments, if a fully scheduled student cannot be re-scheduled with an open section of a particular course, that student is not unscheduled and the re-balancer engine 135 selects another fully scheduled student who is enrolled in a closed section and attempts to schedule that student in an open section. For example, if the re-balancer engine 135 determined that 3 fully scheduled students need to be un-scheduled in order to accommodate the requests of the partially scheduled students, and two of those 3 students cannot be scheduled into an open section because of a course section conflict, then the re-balancer engine 135 selects another two students to replace the two students that should not be un-scheduled because the engine will not be able to maintain their fully scheduled status. Once all closed course sections are processed, at 860 the re-balancer engine 135 invokes the tree search engine 130 and instructs it to schedule only the identified partially scheduled students in previously closed sections. The tree search engine 130 schedules the identified students in a manner described above. Again, it will be appreciated that any algorithm may be invoked to schedule partially scheduled students and embodiments of the invention are not limited to the tree search algorithm.

Once the re-balancer engine 135 attempts to fully schedule all the students in the group, the progress monitor 145 determines whether sufficient progress has been made by engine to invoke the engine again. The functionality of the progress monitor 145 has been described above.

De-gapper

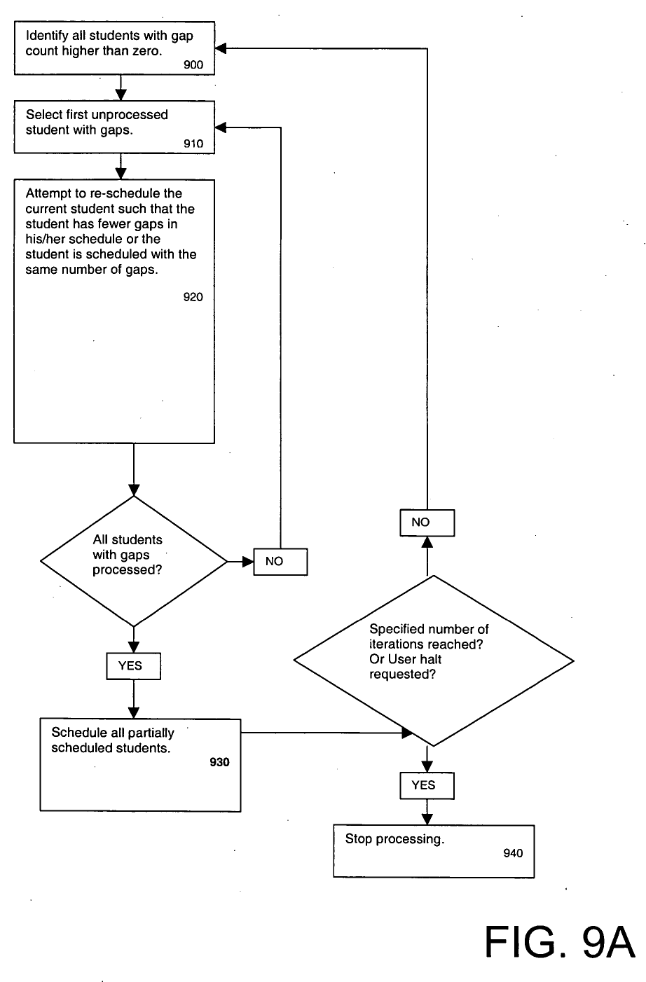

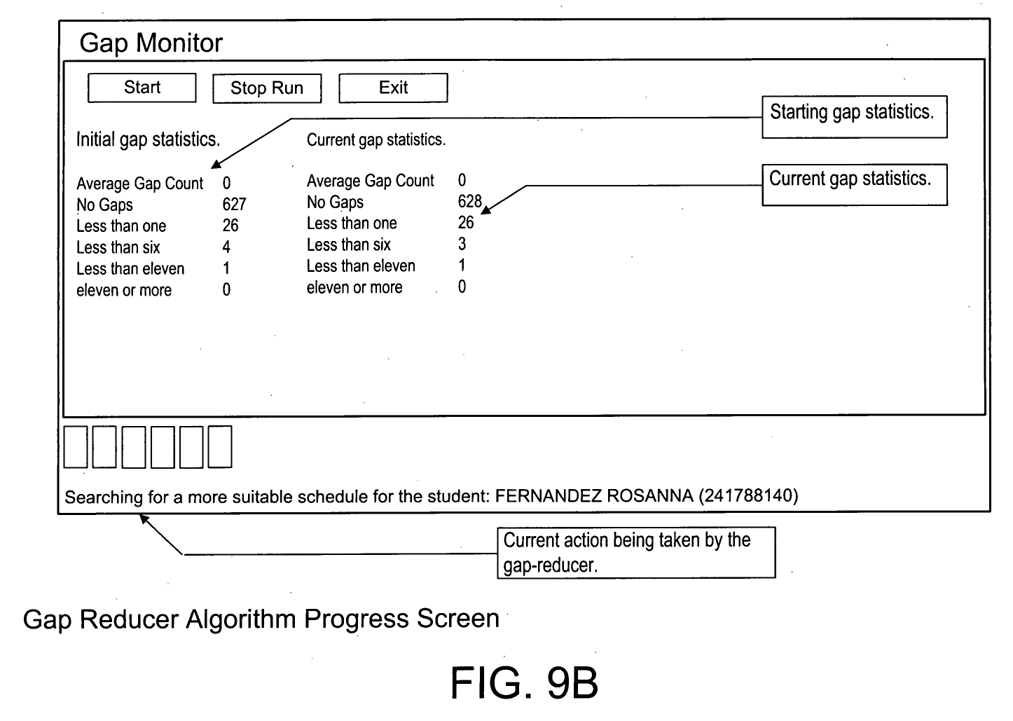

Once the re-balancer engine 135 along with the tree search engine 130 attempts to schedule partially scheduled students into open course sections, scheduling engine invokes the de-gapper engine 140 at 260 of FIG. 2 to execute a de-gapper algorithm according to some embodiments of the invention. At 900 of FIG. 9A the de-gapper engine 140 identifies students that have gaps in their schedules. A gap is a time period between classes in a student's schedule wherein no classes are scheduled. At 910, upon identifying students with gaps in their schedules, the de-gapper engine 140 selects a student from the identified students. At 920 the de-gapper engine 140 invokes the tree search engine to re-schedule the current student such that the student has fewer gaps in his/her schedule. The selected student may also be scheduled with the same number of gaps with a scheduled including a combination of course-sections with higher number of average remaining seats available than the average remaining seats available of the courses of the original schedule from which the student is being un-scheduled. If the tree search engine 130 is able to generate a schedule with fewer or same number of gaps then the student is assigned the new schedule, if the tree search engine is unable to generate a schedule with fewer or the same number of gaps then the student's original schedule is restored. Once all the students with gaps are processed, the de-gapper engine invokes the tree search engine, or any other scheduling algorithm, to schedule remaining partially scheduled students at 930. In some embodiments the number of iterations of the de-gapper engine may be user-specified. In addition, a user may halt iterations of the de-gapper engine.

FIG. 9B illustrates a graphical interface showing scheduling progress of the de-gapper engine according to some embodiments of the invention. It will be appreciated that the interface may present progress information for all the students that the de-gapper engine attempted to re-schedule instead of for each student at the time. In addition, it will be appreciated that a variety of formats may be utilized to present the user of the scheduling system with progress information of the de-gapper engine.

General

According to some embodiments of the invention, once all the students in one group has been scheduled by the above engines, scheduling engine 100 selects the next group and invokes the engines in a manner described above for scheduling student requests. The scheduling process continues until all students have been attempted to be scheduled by the engines.

In summary, once the user invokes the scheduling system, the prioritizer is invoked to prioritize students and student requests. Once the requests and students are prioritized, the first pass engine is invoked. The first pass engine may execute a number of times so long as its subsequent pass scheduling results are better than the previous pass of the engine. Once the first pass engine performs its scheduling, the second pass engine is invoked. As with the first pass engine, the second pass engine may run several times so long as it's the scheduling results of the latest pass are better than the previous pass. The swapper engine is invoked after the second pass engine performed its scheduling. The swapper engine may execute several times as well, so long as its latest pass performs better than the previous pass. Once the swapper engine performs its scheduling, the tree search engine is invoked. The tree search engine may be invoked several times so long as subsequent passes are better than the previous ones. Once the tree search engine has attempted to schedule the students and it's not making enough progress, then the re-balancer engine is invoked which may be invoked several times as well. The de-gapper engine is invoked to perform its scheduling operations after the re-balancer has finished its operations.

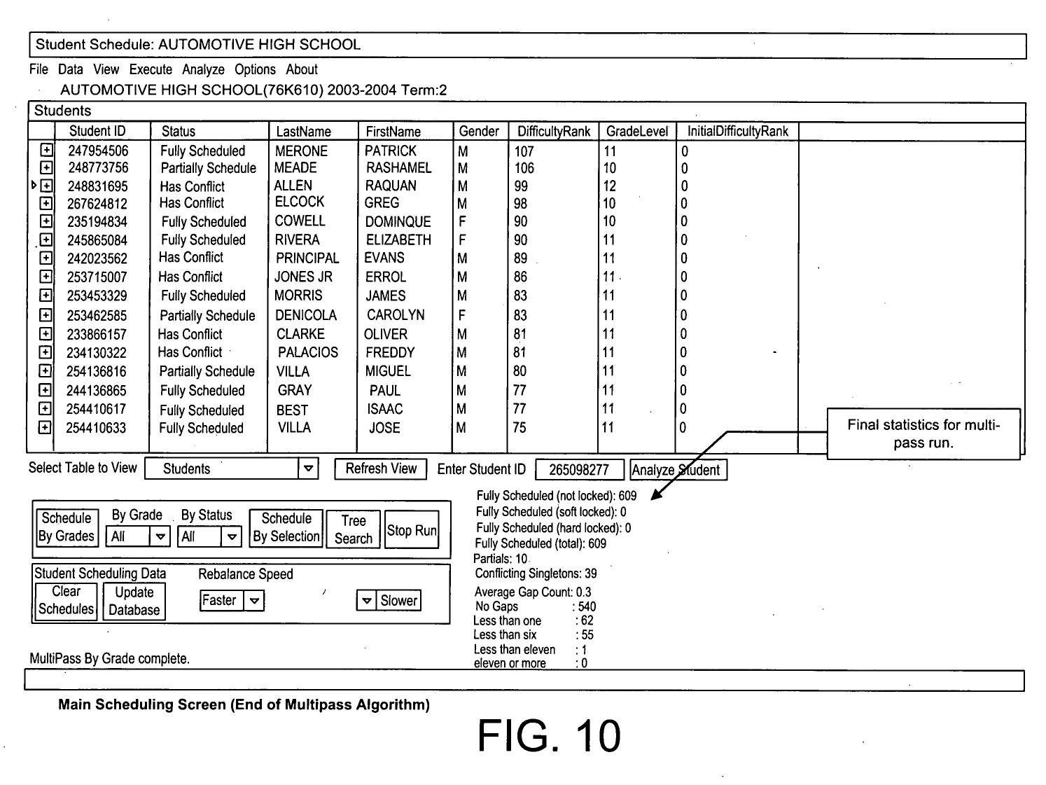

FIG. 10 illustrates a graphical user interface presented to the user of the scheduling system at the end of the execution of all the above-described engines according to some embodiments of the invention. The interface illustrates statistics of the multi-pass run of the algorithms executed by the engines including information on the number of fully scheduled students, partially scheduled students, conflicting singleton courses, gap counts, etc. It will be appreciated that other information can be displayed to the user that the embodiments of the invention are not limited to the information illustrated in FIG. 10.

According to some embodiments of the invention, the user of the scheduling system described above may manually invoke the above-described engines individually. For example, the user may manually invoke the tree search engine 130 instructing it to perfect schedules of students that have gaps in their schedules or were not able to be fully scheduled by the engines. In some embodiments, the user may manually invoke additional engines such as a student request analyzer and a scavenger engine.

Student Request Analyzer

The student request analyzer presents the user with statistics based on original student requests prior to scheduling. For example, the analyzer may present the user with information indicating which courses were problematic and caused the most conflict during scheduling. The user may use this information to modify the master schedule to ensure that all students have the most efficient schedules. The student request analyzer identifies students with requests that include conflicts. For example, the student request analyzer identifies students who requested conflicting singletons, i.e. students that request two or more single section courses that have meeting conflicts. The student request analyzer presents the user with a list of courses that posed such a scheduling problem. The student request analyzer may also identify students that requested virtual singletons. Virtual singletons are courses that are singletons for a given student. The student request analyzer may also identify students whose requests include conflicting virtual singletons, i.e. virtual singleton course that conflicts with either another virtual singleton course or with a singleton course. The student request analyzer may also identify students who requested singleton courses that eliminate sections for several other requested courses. For example, if a singleton course meets every day at periods 2 through 9 and the student requested other courses that meet Period 4 and Period 7 and another course that meets periods 5 and 6, then the student cannot be registered in the singleton course and the other two requested courses because of the scheduling conflict. In some embodiments, the student request analyzer presents the user with schedules of students with conflicted schedules. In some embodiments, the student request analyzer presents the user with a list of problematic courses, such as singleton courses.

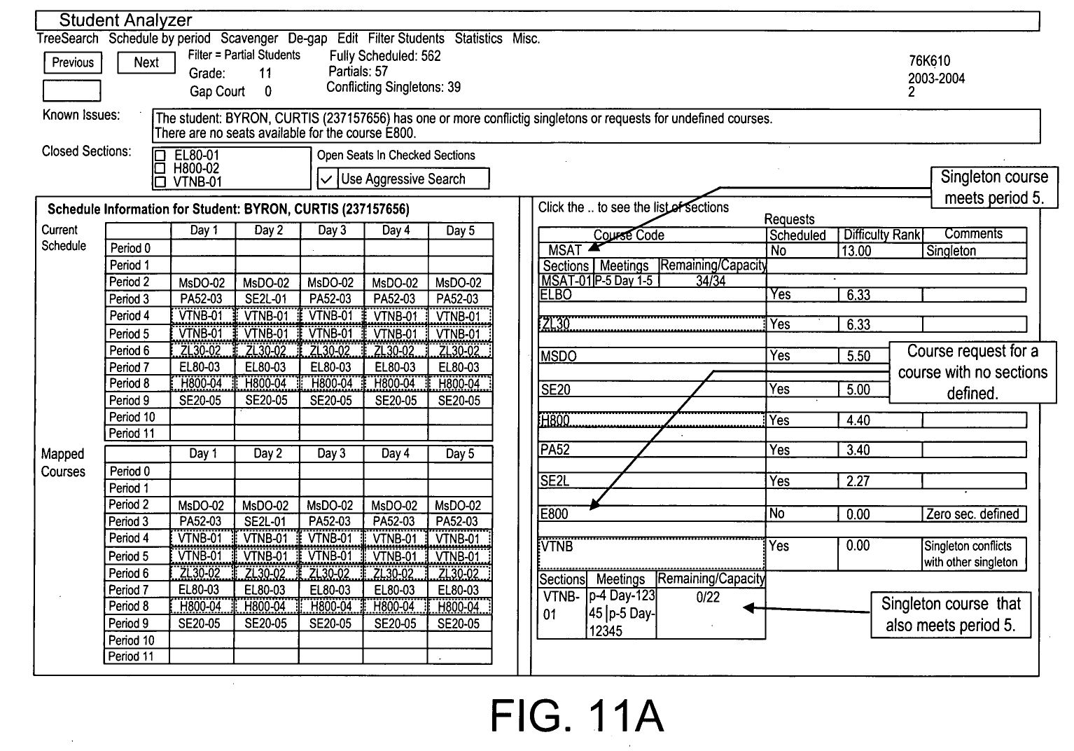

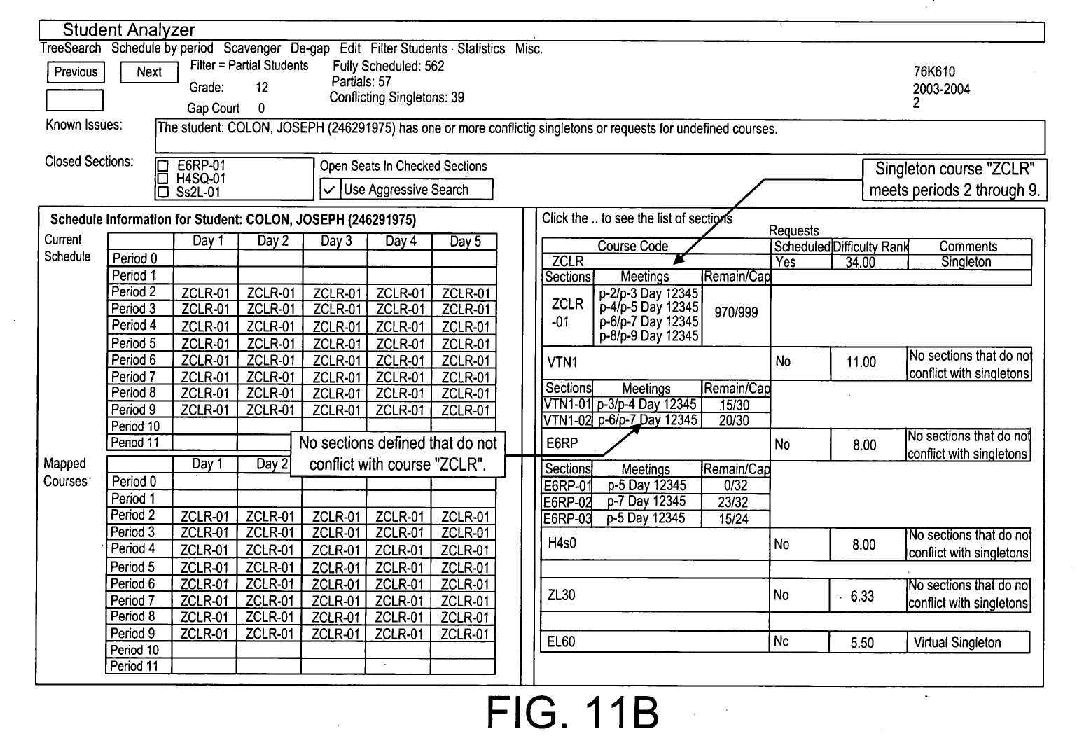

FIGS. 11A and 11B illustrate graphical user interfaces that are presented to the user of the scheduling system according to some embodiments of the invention. FIG. 11A illustrates an exemplary graphical user interface that is presented to the user to indicate that student Curtis Byron cannot be scheduled due to the conflicting singletons MSAT-01 and VTNB-01 and an unresolvable request E800. FIG. 11B illustrates an exemplary graphical user interface that is presented to the user to indicate that student Joseph Colon requests a singleton course ZCLR-01 that conflicts with the course VTN1 that he requested.

Scavenger

According to some embodiments the user may manually invoke the scavenger engine. The scavenger engine attempts to eliminate scheduling problems due to closed course sections. The user may invoke the scavenger engine and specify a student to be scheduled. The scavenger engine identifies courses that are closed for this particular student. Upon identifying such courses, the scavenger engine selects a student from each of the identified closed sections and un-schedules that student from the closed section. Once the scavenger engine un-schedules one student from each closed section, it invokes the tree search engine and instructs it to schedule the original partially scheduled student and the un-scheduled students. In some embodiments the user may invoke the scavenger engine and instruct it to schedule all the partially scheduled students. The scavenger engine then attempts to schedule all the partially scheduled students in the manner described above, i.e. by identifying courses that are closed for each student and attempting to free up a seat in each of those closed courses. In some embodiments the scavenger engine schedules partially scheduled students based on student degree of difficulty, starting with the most difficult students and ending with the least difficult students. If successful schedules were not generated, then the original student schedules are restored.

Schedule-by-period

According to some embodiments, the user may also manually invoke a schedule-by-period engine in order to satisfy requests of the partially unscheduled students. The partially scheduled students are first unscheduled by the schedule-by-period engine. The schedule-by-period engine schedules student requests by scheduling singleton courses first. For example, if a partially scheduled student Mary requested two singleton course, then the schedule-by-period engine schedules the two singleton courses first. Then, the schedule-by-period engine randomly selects a request from the remaining student requests and attempts to schedule it into the available periods remaining after scheduling of singleton courses. The schedule-by-period engine starts with the requests with highest degree of difficulty and ends with the requests with least degree of difficulty. In some embodiments, the schedule-by-period engine back-tracks if it runs into a scheduling conflict. For example, if the schedule-by-period selected an English 101 section that meets during Period 4 for Henry's schedule, and the next request, Math 101, only meets during Period 4, then the schedule-by-period back-tracks and selects different section of English 101 in order to satisfy Henry's Math 101 request.

It will be appreciated by one skilled in the art that although the embodiments have been described with reference to school environments, the invention can be applied to any tasks involving scheduling and the embodiments are not limited to the school courses scheduling tasks.

Exemplary Operating Environment

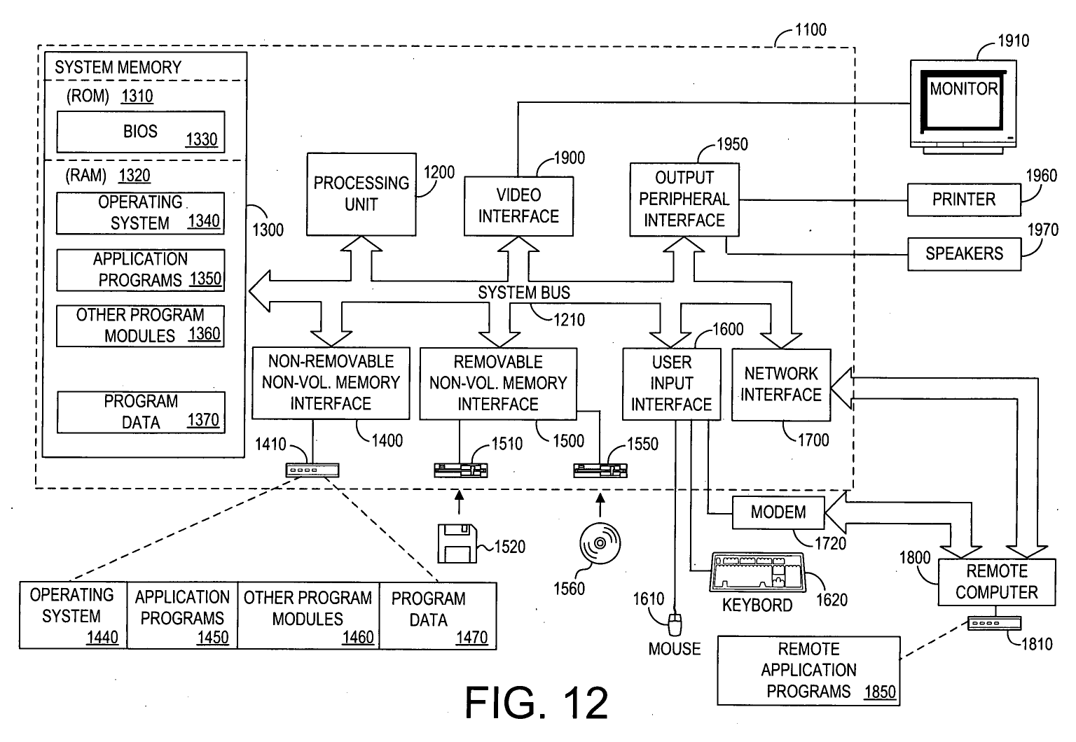

FIG. 12 illustrates an example of a suitable operating environment 1000 in which the invention may be implemented. The operating environment 1000 is only one example of a suitable operating environment and is not intended to suggest any limitation as to the scope of use or functionality of the embodiments of the invention. Other well known computing systems, environments, and/or configurations that may be suitable for use with the embodiments of the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

Embodiments of the invention is operational with numerous other general purpose or special purpose computing system environments or configurations. Examples of well known computing systems, environments, and/or configurations that may be suitable for use with the embodiments of the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like. It will be appreciated by one skilled in the art that components of the embodiments of the invention may be distributed among a number of computing systems, for example, in a client-server configuration.

Embodiments of the invention may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

With reference to FIG. 10, an exemplary system for implementing the embodiments of the invention includes a general purpose computing device in the form of a computer 1100. Components of computer 1100 may include, but are not limited to, a processing unit 1200, a system memory 1300, and a system bus 1210 that couples various system components including the system memory to the processing unit 1200. The system bus 1210 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 1100 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1100. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1300 includes computer storage media in the form of volatile and/or nonvolatile memory such as read only memory (ROM) 1310 and random access memory (RAM) 1320. A basic input/output system 1330 (BIOS), containing the basic routines that help to transfer information between elements within computer 1100, such as during start-up, is typically stored in ROM 1310. RAM 1320 typically contains data and/or program modules that are immediately accessible to and/or presently being operated on by processing unit 1200. By way of example, and not limitation, FIG. 1 illustrates operating system 1340, application programs 1350, other program modules 1360, and program data 1370.

The computer 1100 may also include other removable/non-removable, volatile/nonvolatile computer storage media. By way of example only, FIG. 10 illustrates a hard disk drive 1400 that reads from or writes to non-removable, nonvolatile magnetic media, a magnetic disk drive 1510 that reads from or writes to a removable, nonvolatile magnetic disk 1520, and an optical disk drive 1550 that reads from or writes to a removable, nonvolatile optical disk 1560 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1410 is typically connected to the system bus 1210 through an non-removable memory interface such as interface 1400, and magnetic disk drive 1510 and optical disk drive 1550 are typically connected to the system bus 1210 by a removable memory interface, such as interface 1500.

The drives and their associated computer storage media discussed above and illustrated in FIG. 10, provide storage of computer readable instructions, data structures, program modules and other data for the computer 1100. In FIG. 10, for example, hard disk drive 1410 is illustrated as storing operating system 1440, application programs 1450, other program modules 1460, and program data 1470. Note that these components can either be the same as or different from operating system 1340, application programs 135, other program modules 1360, and program data 1370. Operating system 1440, application programs 1450, other program modules 1460, and program data 1470 are given different numbers here to illustrate that, at a minimum, they are different copies. A user may enter commands and information into the computer 2000 through input devices such as a keyboard 1620 and pointing device 1610, commonly referred to as a mouse, trackball or touch pad. Other input devices (not shown) may include a microphone, joystick, game pad, satellite dish, scanner, or the like. These and other input devices are often connected to the processing unit 1200 through a user input interface 1600 that is coupled to the system bus, but may be connected by other interface and bus structures, such as a parallel port, game port or a universal serial bus (USB). A monitor 1910 or other type of display device is also connected to the system bus 1210 via an interface, such as a video interface 1900. In addition to the monitor, computers may also include other peripheral output devices such as speakers 1970 and printer 1960, which may be connected through a output peripheral interface 1900.

The computer 1100 may operate in a networked environment using logical connections to one or more remote computers, such as a remote computer 1800. The remote computer 1800 may be a personal computer, a server, a router, a network PC, a peer device or other common network node, and typically includes many or all of the elements described above relative to the computer 1100, although only a memory storage device 1810 has been illustrated in FIG. 10. The logical connections depicted in FIG. 10 include a local area network (LAN) 1710 and a wide area network (WAN) 1730, but may also include other networks. Such networking environments are commonplace in offices, enterprise-wide computer networks, intranets and the Internet.

When used in a LAN networking environment, the computer 1100 is connected to the LAN 1710 through a network interface or adapter 1700. When used in a WAN networking environment, the computer 1100 typically includes a modem 1720 or other means for establishing communications over the WAN 1730, such as the Internet. The modem 1720, which may be internal or external, may be connected to the system bus 1210 via the user input interface 160, or other appropriate mechanism. In a networked environment, program modules depicted relative to the computer 1100, or portions thereof, may be stored in the remote memory storage device. By way of example, and not limitation, FIG. 10 illustrates remote application programs 1850 as residing on memory device 1810. It will be appreciated that the network connections shown are exemplary and other means of establishing a communications link between the computers may be used.

Thus, methods and apparatuses for event scheduling have been described. Although the invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

1. A computer-implemented method comprising:
executing a current algorithm in a sequence of algorithms performing specified scheduling functions;
determining a level of progress made by the current algorithm;
executing the current algorithm while the level of progress meets predetermined criteria; and
invoking a next algorithm in the sequence if the level of progress does note meet the predetermined criteria.

2. The method of claim 1, wherein the sequence of algorithms comprises a plurality of algorithms to schedule courses for a plurality of students based on a master course schedule.

3. The method of claim 1, wherein the sequence of algorithms is executed based on a set of user predefined rules.

4. The method of claim 1, wherein the sequence of algorithms is executed based on dynamic rules.

5. The method of claim 2, further comprising characterizing course requests and prioritizing students and the course requests.

6. The method of claim 1, further comprising dividing objects to be scheduled into groups and invoking the sequence of algorithms for each group.

7. The method of claim 2, further comprising executing a first pass algorithm in the sequence of algorithms, wherein the first pass algorithm identifies complimentary course sections for each student.

8. The method of claim 2, further comprising executing a second pass algorithm in the sequence of algorithms, wherein the second pass algorithm identifies closed course sections, un-schedules fully scheduled students from the closed course sections and schedules partially scheduled students in the closed course sections.

9. The method of claim 8, wherein the second pass algorithm further determines a number of fully schedules students to un-schedules based on a number of partially schedules students and a rate of un-scheduling.

10. The method of claim 2, further comprising executing a swapper algorithm from the plurality of algorithms, wherein the swapper algorithm identifies fully scheduled students, un-schedules the identifies students and schedules partially scheduled students.

11. The method of claim 10, wherein the swapper algorithm further determines a number of fully schedules students to un-schedules based on a number of partially schedules students and a rate of un-scheduling.

12. The method of claim 2, further comprising executing a tree search algorithm.

13. The method of claim 12, wherein the tree search algorithm is branch limited and time limited.

14. The method of claim 2, further comprising executing a re-balancer algorithm from the plurality of algorithms, wherein the re-balancer algorithm un-schedules fully scheduled students from closed course sections and schedules partially schedules students.

15. The method of claim 14, wherein a number of fully schedules students to be schedules is based on a ratio of a number of fully schedules students over a number of partially schedules students and a number of closed course sections over a number of open course sections.

16. The method of claim 2, further comprising executing a de-gapper algorithm from the plurality of algorithms wherein the de-gapper algorithm identifies students with gaps in schedules and re-schedules the students with fewer gaps in schedules.

17. The method of claim 2, further comprising enabling the user to invoke a student request analyzer to request scheduling statistics information.

18. The method of claim 2, further comprising enabling the user to invoke a scavenger algorithm, wherein the scavenger algorithms eliminates scheduling problems due to closed course sections.

19. The method of claim 2, further comprising enabling the user to invoke a schedule-by-period algorithm, wherein the schedule-by-period algorithm schedules partially schedules students based on degree of difficulty of course requests and periods.

20. The method of claim 1, further comprising displaying scheduling statistics to a user while the sequence of algorithms is executed and displaying final scheduling statistics to the user at the end of execution of the sequence of algorithms.

21. A computer-implemented scheduling system comprising:
a first engine to execute a current algorithm in a sequence of algorithms performing specified scheduling functions;
a progress monitor to determine a level of progress made by the current algorithm monitor; and
a second engine to invoke a next algorithm in the sequence if the level of progress does not meet the predetermined criteria.

22. The method of claim 21, wherein the sequence of algorithms comprises a plurality of algorithms to schedule courses for a plurality of students based on a master course schedule.

23. The method of claim 21, wherein the sequence of algorithms is executed based on a set of user predefined rules.

24. The method of claim 21, wherein the sequence of algorithms is executed based on a set of dynamic rules.

25. An article of manufacture comprising:
a computer-readable medium having stored therein a computer program executable by a processor, the computer program comprising instructions for:
executing a current algorithm in a sequence of algorithms performing specified scheduling functions;
determining a level of progress made by the current algorithm;
executing the current algorithm while the level of progress meets predetermined criteria; and
invoking a next algorithm in the sequence if the level of progress does not meet the predetermined criteria.

26. The article of manufacture of claim 25, wherein the sequence of algorithms is executed based on a set of user predefined rules.

27. The article of manufacture of claim 25, wherein the sequence of algorithms is executed based on a set of dynamic rules.

28. A computer-implemented scheduling system comprising:
means for executing a current algorithm in a sequence of algorithms performing specified scheduling functions;
means for determining a level of progress made by the current algorithm;
means for executing the current algorithm while the level of progress meets predetermined criteria; and
means for invoking a next algorithm in the sequence if the level of progress does note meet the predetermined criteria.

29. The computer-implemented scheduling system of claim 28, wherein the sequence of algorithms comprises a plurality of algorithms to schedule courses for a plurality of students based on a master course schedule.
